(19) United States
(12) Patent Application Publication
(10) Pub. No.: US 2025/0042049 A1
(43) Pub. Date: Feb. 6, 2025

(54) Hair cutting unit of reciprocating electric shaver

(71) Applicant: Yongkang Tiejun Electrical Appliance Co., Ltd., Jinhua City (CN)

(72) Inventor: Tiejun Tong, Jinhua City (CN)

(73) Assignee: Yongkang Tiejun Electrical Appliance Co., Ltd., Jinhua City (CN)

(21) Appl. No.: 18/781,167

(22) Filed: Jul. 23, 2024

(30) Foreign Application Priority Data
Jul. 31, 2023 (CN) 202310988431.2

(51) Int. Cl. B26B 19/04

(52) U.S. Cl. CPC B26B 19/04

(57) ABSTRACT

A hair cutting unit of reciprocating electric shaver includes an external blade, an internal blade, a support, and a retainer, and the external blade includes a curved wall and two mutually opposite long walls; the support holds the internal blade; the retainer has two mutually opposite retaining walls, wherein the long wall of the external blade is provided with a following hole through which at least one support passes, and the long wall of external blade can move along the support that passes through the following hole. The advantage of the hair cutting unit is that when the cutting unit is subjected to non-uniform pressure from the skin, the curved wall of external blade can continue to wrap around the internal blade without deformation, along with the moving long wall of the external blade, thus maintaining high hair cutting efficiency in actual use.

### REFERENCE TO PRIOR APPLICATION

This application claims priority to Chinese Patent Application 202310988431.2, filed on Jul. 31, 2023, which is incorporated herein by reference.

### TECHNICAL FIELD

The present invention relates to a hair cutting unit of reciprocating electric shaver, to the technical field of reciprocating electric shavers.

### BACKGROUND ART

The external blade of reciprocating electric shaver is an extremely thin foil that is easily deformed and filled with small holes, the curved external blade wraps around the internal blade, and the wrapped internal blade moves back and forth along the common contact surface with the external blade under spring pressure. The hairs that extend into the common contact surface through small holes are cut off, while the ones that extend beyond the common contact surface cannot be cut off because the internal blade here is far from the external blade. In the absence of skin pressure, the internal and external blades maintain an ideal common contact surface, but in actual use, the skin always applies pressure to the internal and external blades in all directions. Under uneven skin pressure, the external blade deforms due to its extreme thinness, while the internal blade shifts due to gaps with adjacent components, resulting in changes in the common contact surface between the internal and external blades. Therefore, the size of the common contact surface between the internal and external blades under uneven skin pressure determines the hair cutting efficiency, that is, the larger the common contact surface, the higher the hair cutting efficiency, and vice versa.

In the existing hair cutting unit, the external blade is fixed on the retainer by welding or riveting and cannot move relative to the retainer, and the internal blade maintains a large gap with the retainer. Under non-uniform pressure from the skin, the internal blade undergoes significant tilt and displacement due to its large gap with the retainer, while the external blade deforms due to being fixed on the retainer and unable to move. The external blade's deformation area stays clear of the internal blade, with reduced common contact area and lower hair cutting efficiency.

### SUMMARY OF THE INVENTION

The present invention proposes a hair cutting unit of reciprocating electric shaver that can maintain high hair cutting efficiency even under non-uniform pressure from the skin.

To achieve the above purpose, the present invention presents the following technical solution: a hair cutting unit of reciprocating electric shaver includes an external blade, an internal blade, a support, and a retainer, the external blade includes a curved wall and two mutually opposite long walls; the support holds the internal blade; the retainer has two mutually opposite retaining walls, wherein the long wall of the external blade is provided with a following hole through which at least one support passes, and the long wall of external blade can move along the support that passes through the following hole.

The retaining wall is provided with a support hole through which at least one support passes.

The retainer is provided with a connecting portion to connect two mutually opposite retaining walls, both the connecting portion and the retaining walls are metal sheets.

The connecting portion is bent so that the two mutually opposite retaining walls are not parallel, and the distance between the retaining walls near the connecting portion is greater than that between the retaining walls far from the connecting portion.

The retaining wall is provided with a boss, the long wall of external blade is in contact with the boss and is far away from the support hole.

The support has an end portion and a middle portion, the end portion can pass through the support hole, and the middle portion cannot pass through the support hole.

The support is made of metal, the end portion and middle portion are cylindrical and have different diameters.

Based on the present invention, a hair cutting unit of reciprocating shaver can maintain high hair cutting efficiency, even under non-uniform pressure from the skin during actual use.

### BRIEF DESCRIPTION OF THE DRAWINGS

The accompanying drawings required for embodiment explanation are described briefly below in order to provide a more explicit explanation of the embodiments of the present invention.

FIG. 1 is a schematic diagram of an external blade in the embodiment of the present invention.

FIG. 2 is a schematic diagram of a support in the embodiment of the present invention.

FIG. 3 is a schematic diagram of a retainer in the embodiment of the present invention.

FIG. 4 is a schematic diagram of an internal blade in the embodiment of the present invention.

FIG. 5 is a cross-sectional view of an embodiment of the present invention.

FIG. 6 is an exploded view of an embodiment of the present invention.

FIG. 7 is a partial cross-sectional view of an embodiment of the present invention.

FIG. 8 is a cross-sectional view of a retainer that is not installed in the embodiment of the present invention.

FIG. 9 is a cross-sectional view of the embodiment of the present invention showing only the support and retainer.

FIG. 10 is a schematic diagram of an embodiment of the present invention showing only the external blade, support, and internal blade.

FIG. 11 is a schematic diagram of FIG. 10 under non-uniform pressure from the skin.

Where: 1—External blade; 11—Following hole; 12—Curved wall of external blade; 13—Long wall of external blade; 2—Support; 21—Middle portion; 22—End portion; 3—Retainer; 31—Connection portion; 32—Retaining wall; 33—Support hole; 34—Boss; 4—Internal blade; 101—Common contact surface.

### DETAILED DESCRIPTION OF THE EMBODIMENTS

The specific embodiments of the present invention will be further elaborated below in conjunction with the accompanying drawings.

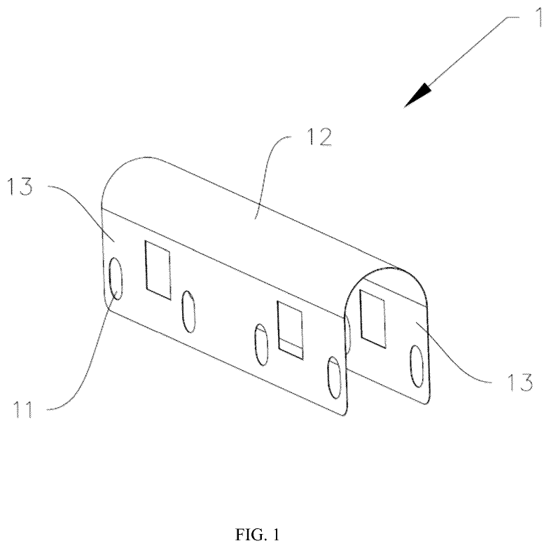

As shown in FIG. 1, the external blade 1 in this embodiment is a metal foil with eight following holes 11, one curved wall 12 of external blade, and two mutually opposite long walls 13 of external blade.

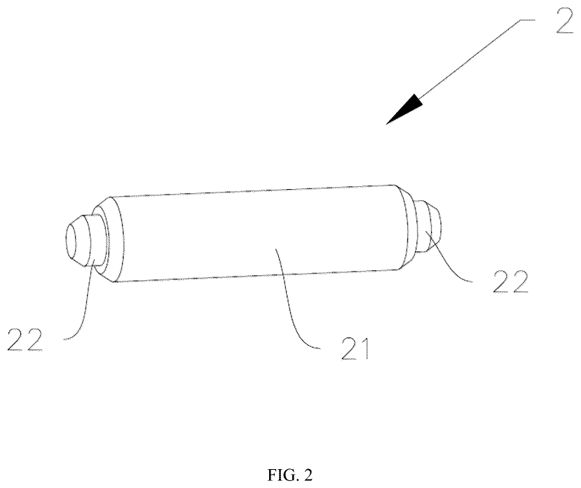

As shown in FIG. 2, in this embodiment, the support 2 is a section of metal, and has a middle portion 21 and two end portions 22, and the middle portion 21 and end portion 22 are both cylindrical, and the middle portion 21 has a larger diameter than the end portion 22.

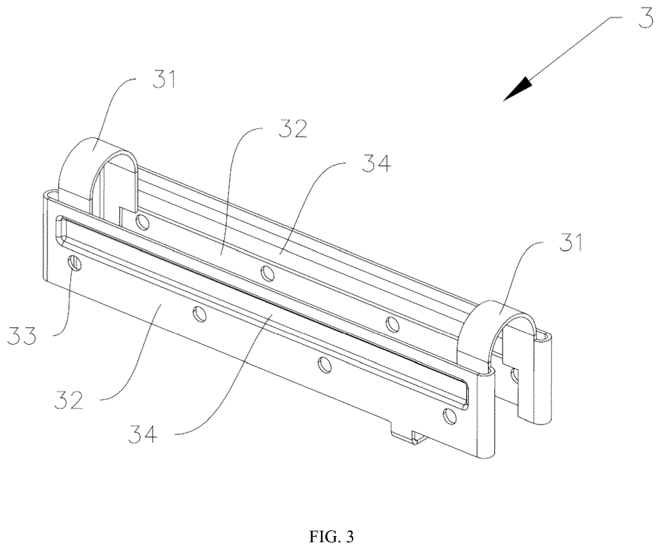

As shown in FIG. 3, in this embodiment, the retainer 3 has a connecting portion 31 and two mutually opposite retaining walls 32, the retaining wall 32 is provided with eight support holes 33 and a boss 34, all of which are metal sheets, and the connecting portion 31 is bent into a U shape.

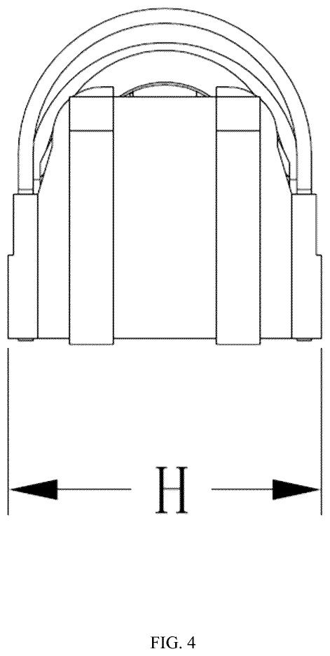

FIG. 4 is a schematic diagram of internal blade 4 with a width of H in this embodiment.

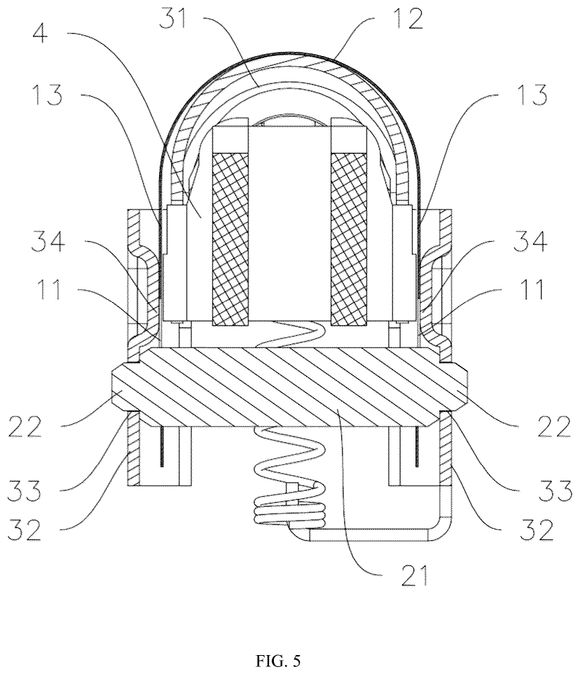

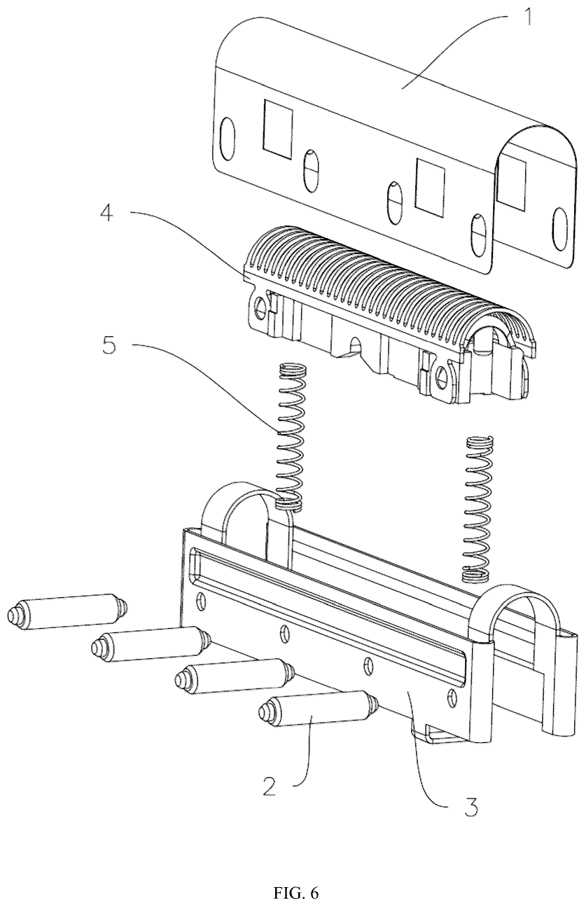

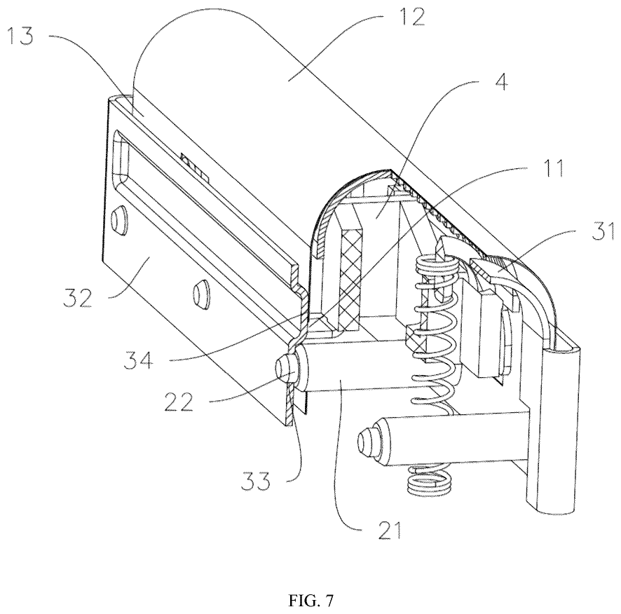

FIG. 5 is a cross-sectional view of the embodiment, FIG. 6 is an exploded view of the embodiment, and FIG. 7 is a local cross-sectional view of the embodiment. This embodiment has one external blade 1, four supports 2, one retainer 3, one internal blade 4, and two springs 5. Both ends of the four supports 2 pass through 8 following holes 11 on the long wall 13 of the external blade, and the following holes 11 have a width slightly larger than the diameter of the middle portion 21, so that the long wall 13 of external blade can move along the middle portion 21. Afterwards, the end 22 of the four supports 2 pass through the eight support holes 33 on the retaining wall 32, and the end face of middle portion 21 is pressed against the retaining wall 32. The long wall 13 of external blade sticks to the boss 34 on the retaining wall 32, so that the long wall 13 of external blade is kept away from the support hole 33, and the long wall 13 of external blade will not get stuck in the gap between the middle portion 21 and the retaining wall 32 when moving along the middle portion 21. The internal blade 4 is located between the two long walls 13 of external blade, and two springs 5 make the internal blade 4 tightly adhere to the curved wall 12.

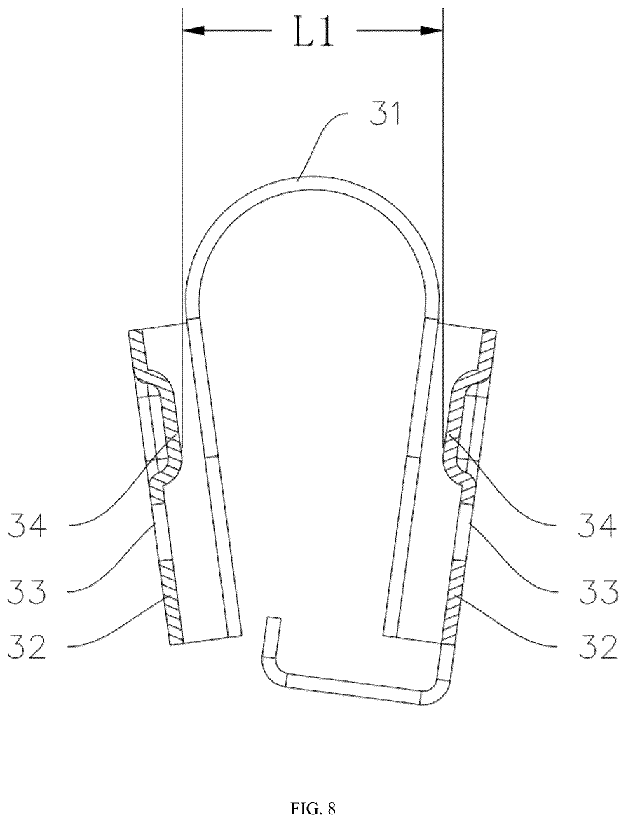

FIG. 8 is a cross-sectional view of the retaining member 3 when it is not installed in this embodiment. After bending the connecting part 31 in the figure, the two opposite retaining walls 32 are not parallel. The distance between the two retaining walls 32 is greater near the connecting part 31 than away from the connecting part 31, as shown in the figure. The minimum distance L1 between the protrusions 34 is smaller than the width H of the internal blade 4.

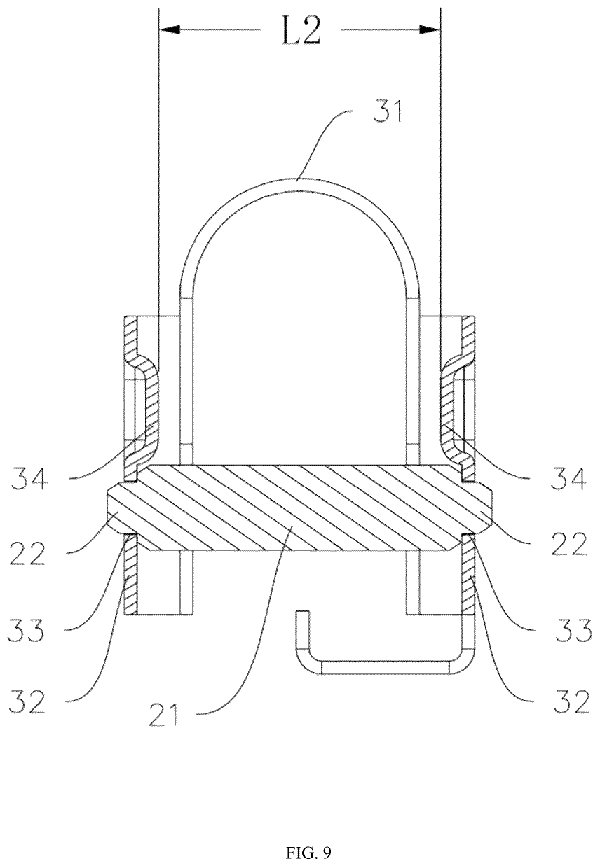

FIG. 9 is a cross-sectional view of the embodiment showing the support 2 and retaining member 3 only. After the end 22 of the support 2 passes through the support hole 33 on the retaining wall 32, the middle portion 21 has a greater diameter than the support hole 33, the two retaining walls 32 are supported by the support 2, and the minimum distance L2 between the bosses 34 is slightly larger than the width H of the internal blade 4. Therefore the gap between the internal blade 4 and the two bosses 34 can be controlled when the length of the middle portion 21 is controlled. A sufficiently small gap can ensure the free reciprocating motion of internal blade 4 and also a sufficiently small tilt and displacement of internal blade 4 under non-uniform pressure from the skin. In this embodiment, both the support 2 and the retainer 3 are made of metal so that they can be welded together to be more rigid.

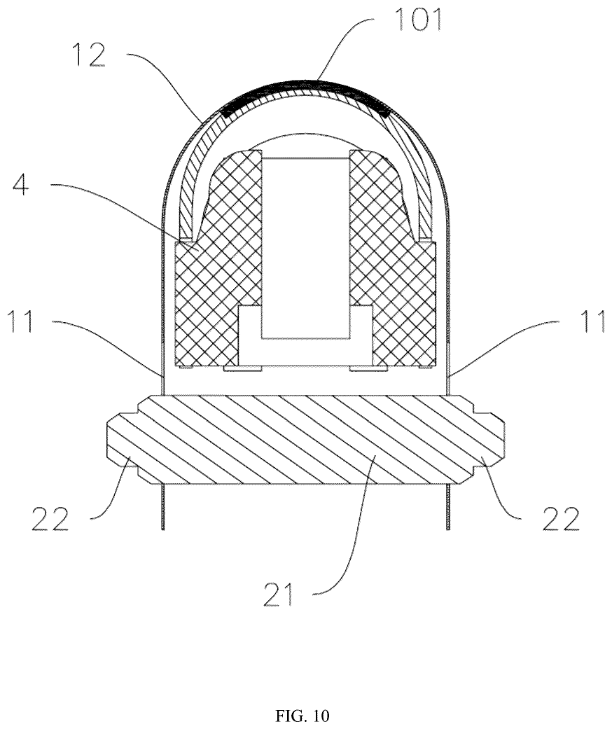

FIG. 10 is a schematic diagram of the embodiment showing external blade 1, support 2, and internal blade 4 only. In the figure, both ends of the support 2 pass through the following hole 11 respectively, and the width of the following hole 11 is slightly larger than the diameter of middle portion 21, so that the long wall 13 of external blade can move along the middle portion 21 in the up and down direction as shown in the view. The view illustrates that the cutting unit faces no pressure from the skin, and there is an ideal common contact surface 101 between the internal blade 4 and the curved wall 12 of external blade.

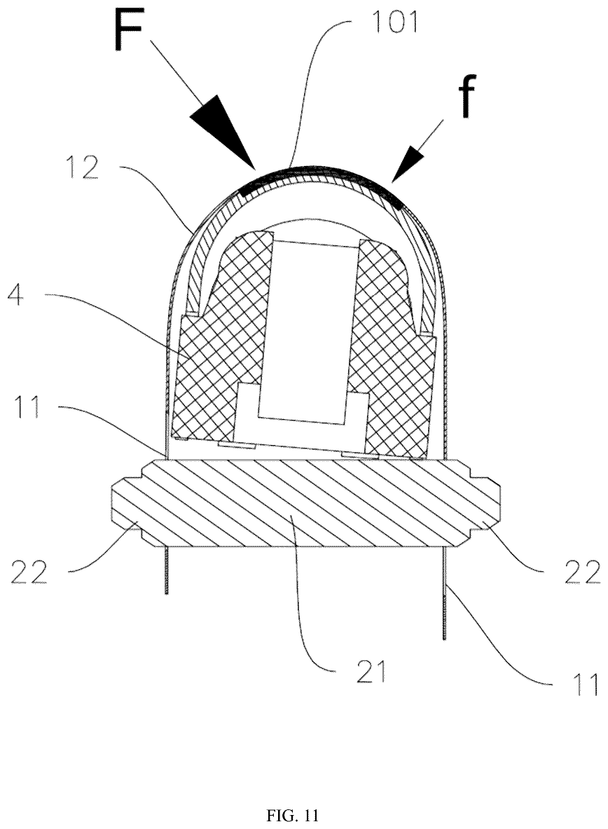

FIG. 11 is a schematic diagram of FIG. 10 under non-uniform pressure from the skin. When the pressure F in the figure is greater than f, the internal blade 4 experiences a slight tilt and displacement, and the long wall 13 of external blade moves along the middle portion 21 in a downward direction as shown in the view. The left long wall 13 of external blade has a small displacement, while the right long wall 13 of external blade has a large displacement, so that the curved wall 12 of external blade can continue to wrap around the internal blade 4 without deformation, along with the moving long wall 13 of external blade, and the common contact surface 101 between the internal blade 4 and the curved wall 12 of external blade remains the same, thus maintaining high hair cutting efficiency.

What is claimed is:

1. A hair cutting unit of reciprocating electric shaver, including an external blade, an internal blade, a support member, and a retaining member;
the external blade includes a curved wall and two mutually opposite long walls;
the support holds the internal blade;
the retainer has two mutually opposite retaining walls;
wherein the long wall of external blade is provided with a following hole through which at least one support passes, and the long wall of external blade can move along the support that passes through the following hole.

2. The hair cutting unit of reciprocating electric shaver according to claim 1, wherein the retaining wall is provided with a support hole through which at least one support passes.

3. A hair cutting unit of reciprocating electric shaver according to claim 1, wherein the retainer is provided with a connecting portion to connect two mutually opposite retaining walls, both the connecting portion and the retaining walls are metal sheets.

4. A hair cutting unit of reciprocating electric shaver according to claim 3, wherein the connecting portion is bent so that the two mutually opposite retaining walls are not parallel, and the distance between the retaining walls near the connecting portion is greater than that between the retaining walls far from the connecting portion.

5. A hair cutting unit of reciprocating electric shaver according to claim 1, wherein the retaining wall is provided with a boss, the long wall of external blade is in contact with the boss and is far away from the support hole.

6. A hair cutting unit of reciprocating electric shaver according to claim 1, wherein the support has an end portion and a middle portion, the end portion can pass through the support hole, and the middle portion cannot pass through the support hole.

7. A hair cutting unit of reciprocating electric shaver according to claim 6, wherein the support is made of metal, the end portion and middle portion are cylindrical and have different diameters.
